(19) United States
(12) Patent Application Publication
(10) Pub. No.: US 2012/0276395 A1
(43) Pub. Date: Nov. 1, 2012

(54) CASING WITH CERAMIC SURFACE AND MANUFACTURING METHOD THEREOF

(76) Inventors: Fei-Lin Yang, Taipei (TW); Yang-Po Chiu, Taipei (TW); Chun-Kai Chou, Taipei (TW)

(21) Appl. No.: 13/458,550

(22) Filed: Apr. 27, 2012

Related U.S. Application Data
(60) Provisional application No. 61/479,649, filed on Apr. 27, 2011.

(51) Int. Cl. B32B 9/04; C04B 35/64; B05D 3/02

(52) U.S. Cl. 428/448; 427/376.4

(57) ABSTRACT

A manufacturing method of a casing with a ceramic surface comprises the steps of: forming a ceramic oxidation layer on a surface of a metal shell; forming a ceramic material on the ceramic oxidation layer; and sintering the ceramic material. Accordingly, the metal casing can be formed with a ceramic surface, which can solve the problem of high shrinkage rate.

### CROSS REFERENCE TO RELATED APPLICATIONS

The non-provisional patent application claims priority to U.S. provisional patent application with Ser. No. 61/479,649 filed on Apr. 27, 2011. This and all other extrinsic materials discussed herein are incorporated by reference in their entirety.

### BACKGROUND OF THE INVENTION

1. Field of Invention

The disclosure relates to a casing and a manufacturing method thereof, and in particular, to a casing with a ceramic surface and a manufacturing method thereof.

2. Related Art

Technologies for manufacturing electronic products are progressive gradually. At the mean time, the appearance of the electronic product also becomes a critical factor for attracting the customers. One of the most popular appearances is to form a ceramic surface on the shell of the electronic product. The proper ceramic appearances provide various images and styles to the electronic products, thereby improving the product competitiveness.

In general, there are two major methods to fabricate the casing with a ceramic surface. One method is to directly use a ceramic material to form the entire casing, but this method increases the overall weight of the electronic product, and the electronic product is easily broken. The other method is to form a ceramic material on the surface of the original metal shell, followed by sintering and annealing for forming the desired ceramic surface. However, the shrinkage rate of the ceramic surface fabricated by this method is very high (up to 20-30%), so it can not satisfy the precise requirement.

### SUMMARY OF THE INVENTION

A casing with a ceramic surface and a manufacturing method thereof that forms the ceramic surface on the metal shell are provided.

A manufacturing method of a casing with a ceramic surface of the disclosure comprises the steps of: forming a ceramic oxidation layer on a surface of a metal shell; forming a ceramic material on the ceramic oxidation layer; and sintering the ceramic material.

A casing of the disclosure comprises a metal shell, a ceramic oxidation layer disposed on a surface of the metal shell, and a ceramic layer disposed on the ceramic oxidation layer.

As mentioned above, the manufacturing method of a casing with a ceramic surface of the disclosure is to form a ceramic oxidation layer on the surface of the metal shell, form the ceramic material on the ceramic oxidation layer, and sinter the ceramic material. Accordingly, the ceramic oxidation layer is configured between the ceramic layer and the metal shell for buffering the difference due to the different heat expansion coefficients of different materials, thereby reducing the shrinkage rate while sintering the ceramic material.

In addition, since the ceramic oxidation layer can enhance the heat duration of the ceramic material, the low-temperature glaze (including PbO) is unnecessary, which makes the manufacturing method more environmental friendly. Moreover, the ceramic oxidation layer can further enhance the heat duration of the metal shell, so that the metal shell can be protected during the sintering, thereby increasing the production yield.

These and other features, aspects and advantages of the disclosure will become better understood with regard to the following description, appended claims, and accompanying drawings.

### BRIEF DESCRIPTION OF THE DRAWINGS

FIG. 1 is a flow chart showing a manufacturing method of a casing with a ceramic surface according to an embodiment of the disclosure; and

FIGS. 2A to 2C are schematic diagrams showing the manufacturing steps of the casing according to the embodiment of the disclosure.

### DETAILED DESCRIPTION OF THE INVENTION

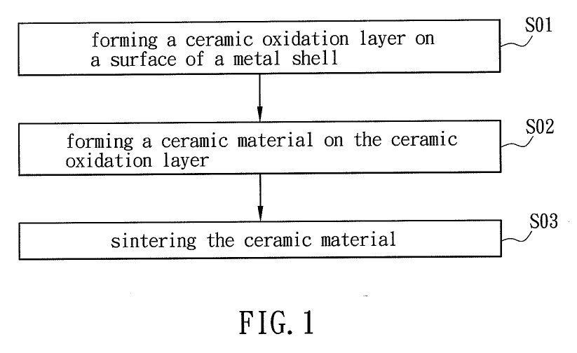

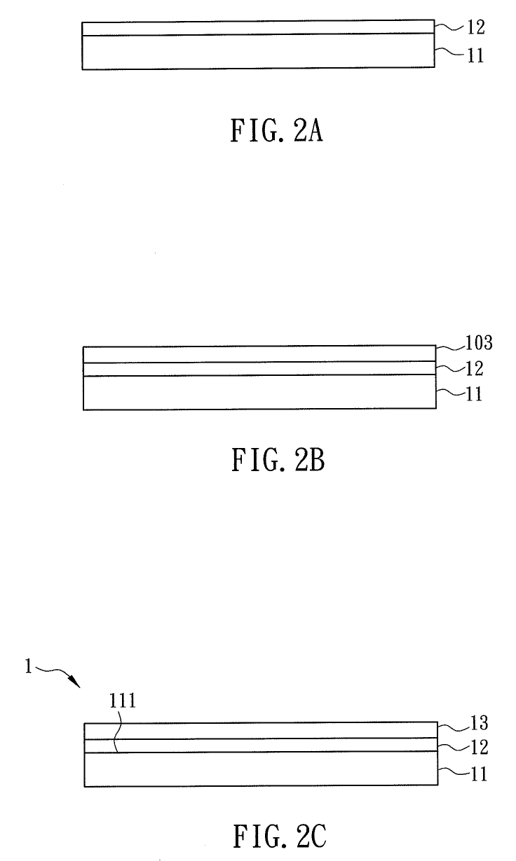

FIG. 1 is a flow chart showing a manufacturing method of a casing with a ceramic surface according to an embodiment of the disclosure, and FIGS. 2A to 2C are schematic diagrams showing the manufacturing steps of the casing. The manufacturing method includes the following steps S01 to S03, which will be described hereinafter with reference to FIGS. 1 and 2A to 2C.

The step S01 is to form a ceramic oxidation layer 12 on a surface of a metal shell 11. The material of the metal shell 11 comprises at least one metal (e.g. copper or iron), at least one alloy (e.g. magnesium alloy, aluminum alloy, or zinc alloy), or their combination. The metal shell 11 can be prepared by injection, casting, forging, semisolid injection or the likes, but not limited to.

The ceramic oxidation layer 12 can be formed by a micro arc oxidation process or a plasma electrolytic oxidation process.

In one embodiment of micro arc oxidation process, the metal shell 11 is dipped into an electrolyte. After conducting the positive sample plate and the negative electrode, an oxide insulation layer is formed on the surface of the metal shell 11. The voltage is still applied after the oxide insulation layer is formed.

When the voltage applied to the metal shell 11 exceeds the threshold value, the weaker part of the oxide insulation layer is broken and the micro arc discharge is generated. After the weaker part of the oxide insulation layer is broken, a new oxide film can be formed on the broken part immediately. If the voltage is continuously applied, another weaker part of the oxide insulation layer is then broken. After repeating several times of the above reactions, a ceramic oxidation layer 12 can be formed on the metal shell 11. The surface of the ceramic oxidation layer 12 is not planar due to the above broken parts and the following formation of oxide films at the broken parts. This feature can sufficiently enhance the attaching ability of the ceramic material to the ceramic oxidation layer 12.

In particular, the metal shell 11 made of magnesium alloy, aluminum ally or zinc ally is suitable for the micro arc oxidation process or plasma electrolytic oxidation process. In these cases, the formed ceramic oxidation layer may include aluminum oxide, magnesium oxide, or zinc oxide. However, the disclosure is not limited to these examples.

In one embodiment, when the material of the metal shell 11 comprises copper or iron, the ceramic material can be disposed on the surface of the metal shell 11 by thermal spraying to form the ceramic oxidation layer 12. In this case of using thermal spraying, the ceramic material can collide with the surface of the metal shell 11 in high speed so as to form a lot of holes on the surface of the ceramic oxidation layer 12. Thus, the surface of the ceramic oxidation layer 12 is not planar, which can enhance the attaching ability of the ceramic material to the ceramic oxidation layer 12 in the following steps.

In this embodiment, the thickness of the ceramic oxidation layer 12 is, for example, larger than 15 μm, which is not limited herein.

The step S02 is to form a ceramic material 103 on the ceramic oxidation layer 12. The ceramic material can be formed on the ceramic oxidation layer 12 by spray coating, screen printing, transfer printing, roll coating, dip coating, electrostatic coating, or jet printing, but not limited to.

In this embodiment, the ceramic material can be sintered in advance and then grinded to obtain powder (15-50 μm). The powder is then mixed with filler and solution so as to prepare the mixture for the step S02 of forming the ceramic material on the ceramic oxidation layer 12. In this case, the thickness of the ceramic material 103 is properly controlled to be less than 100 μm.

The step S03 is to sinter the ceramic material 103. The sintering step S03 is performed under an oxygen isolation circumstance. In this embodiment, after the ceramic material 103 is formed on the ceramic oxidation layer 12, the product is cooled down to room temperature for a while, and dried. Then, the ceramic material 103 as well as the ceramic oxidation layer 12 and metal shell 11 are sent into a furnace.

Nitrogen or inert gas (e.g. argon or hydrogen) is provided to isolate oxygen and heating the ceramic material 103 by heat conduction. After sintering under 350-360° C. for 10-15 minutes, the furnace is turned off and slowly cooled to room temperature. Accordingly, the ceramic material 103 can form the desired ceramic layer 13. In this case, the furnace, such as a continuous furnace or a batch-type furnace, is able to isolate oxygen and can be applied with specific gas.

The ceramic layer 13 can be further processed (e.g. polishing) if necessary. Accordingly, the casing 1 with a ceramic surface is manufactured.

Referring to FIG. 2C, a casing 1 according to the embodiment of the disclosure comprises a metal shell 11, a ceramic oxidation layer 12 and a ceramic layer 13. The ceramic oxidation layer 12 is disposed on a surface 111 of the metal shell 11, and the ceramic layer 13 is disposed on the ceramic oxidation layer 12. Since the structure of the casing 1 has been described in the above manufacturing method, the detailed description thereof will be omitted.

In summary, the manufacturing method of a casing with a ceramic surface of the disclosure is to form a ceramic oxidation layer on the surface of the metal shell, form the ceramic material on the ceramic oxidation layer, and sinter the ceramic material.

Accordingly, the ceramic oxidation layer is configured between the ceramic layer and the metal shell for buffering the difference due to the different heat expansion coefficients of different materials, thereby reducing the shrinkage rate while sintering the ceramic material. In addition, since the ceramic oxidation layer can enhance the heat duration of the ceramic material, the low-temperature glaze (including PbO) is unnecessary. This feature makes the manufacturing method of the disclosure more environmental friendly. Moreover, the ceramic oxidation layer can further enhance the heat duration of the metal shell, so that the metal shell can be protected during the sintering, thereby increasing the production yield.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A manufacturing method of a casing with a ceramic surface, comprising the steps of:
forming a ceramic oxidation layer on a surface of a metal shell;
forming a ceramic material on the ceramic oxidation layer; and
sintering the ceramic material.

2. The method of claim 1, wherein the ceramic oxidation layer is formed by a micro arc oxidation process or a plasma electrolytic oxidation process.

3. The method of claim 1, wherein the ceramic oxidation layer is formed by thermal spray.

4. The method of claim 1, wherein the ceramic material is formed on the ceramic oxidation layer by spray coating, screen printing, transfer printing, roll coating, dip coating, electrostatic coating, or jet printing.

5. The method of claim 1, wherein the step of sintering the ceramic material is performed under an oxygen isolation circumstance.

6. The method of claim 1, wherein the material of the ceramic oxidation layer comprises aluminum oxide, magnesium oxide, or zinc oxide.

7. A casing, comprising:
a metal shell;
a ceramic oxidation layer disposed on a surface of the metal shell; and
a ceramic layer disposed on the ceramic oxidation layer.

8. The casing of claim 7, wherein the material of the metal shell comprises metal or alloy.

9. The casing of claim 7, wherein the material of the metal shell comprises magnesium, aluminum, zinc, iron, or copper.

10. The casing of claim 7, wherein the material of the ceramic oxidation layer comprises aluminum oxide, magnesium oxide, or zinc oxide.
